(19) United States
(12) Patent Application Publication
(10) Pub. No.: US 2022/0136221 A1
(43) Pub. Date: May 5, 2022

(54) FAUCET

(71) Applicant: Purity (Xiamen) Sanitary Ware Co., Ltd., Xiamen City (CN)

(72) Inventors: JAMES WU, Taichung City (TW); ALEX WU, Taichung City (TW); CE-WEN YANG, Xiamen City (CN); CHING-YIN WU, Taichung City (TW)

(73) Assignee: Purity (Xiamen) Sanitary Ware Co., Ltd., Xiamen City (CN)

(21) Appl. No.: 17/085,704

(22) Filed: Oct. 30, 2020

(51) Int. Cl. E03C 1/04; B05B 7/04

(52) U.S. Cl. CPC E03C 1/0404; B05B 7/0425

(57) ABSTRACT

A faucet includes a base, an outlet pipe, and an ultrasonic generator. The base has a receiving groove, wherein the receiving groove has an opening formed on an outer surface of the base. The outlet pipe is engaged with the base, and the outlet pipe has an inlet end and an outlet end. The ultrasonic generator is detachably disposed in the receiving groove and could be taken out via the opening. The engaging structure of the ultrasonic generator and the base of the faucet of the present invention could facilitate the storage of the ultrasonic generator and increase the convenience of using the ultrasonic generator.

### BACKGROUND OF THE INVENTION

### Technical Field

The present invention relates generally to a faucet, and more particularly to a faucet with an ultrasonic generator.

### Description of Related Art

In order to increase the cleaning effect of the residual dirt on the surface of the cleaned items and avoid wasting too much water resources during the cleaning process, ultrasonic cleaning is used to improve the cleaning effect currently, and also because ultrasonic cleaning does not require a large amount of water flow, more water saving.

The principle of ultrasonic cleaning is to provide an ultrasonic generator in a receiving groove. When the ultrasonic generator is activated, the liquid in the receiving groove will produce a pressure difference, which produces many tiny bubbles in the liquid. When the tiny bubbles touched the object to be cleaned, an impact will be generated on the surface of the object to be cleaned, in this way, the dirt will leave the surface of the object along with the liquid to achieve the effect of cleaning.

The ultrasonic cleaning can be found in all walks of life. For example, the medical industry cleans medical equipment by ultrasonic cleaning to avoid virus residue; the manufacturing industry removes rust and oil on the surface of metal workpieces by ultrasonic cleaning; or, the ultrasonic generator can be also used when cleaning the dirt on glasses, vegetables, or dinner plates, which not only increases the effect of cleaning, but also reduce the use of detergent. However, if the user needs to use the ultrasonic cleaning, the user must purchase an ultrasonic generator by themselves, but there is no specific space for receiving the ultrasonic generator, which causes inconvenience in access or placement. The aforementioned problems are necessary to be solved.

### BRIEF SUMMARY OF THE INVENTION

In view of the above, the primary objective of the present invention is to provide a faucet with an ultrasonic generator, wherein the ultrasonic generator is detachably engaged with a base of the faucet, increasing the convenience of access and makes the operation faster.

The present invention provides a faucet including a base, an outlet pipe, and an ultrasonic generator. The base has a receiving groove, wherein the receiving groove has an opening formed on an outer surface of the base. The outlet pipe is engaged with the base, wherein the outlet pipe has an inlet end and an outlet end. The ultrasonic generator is detachably disposed in the receiving groove via the opening.

With the aforementioned design, the ultrasonic generator is detachably engaged with the base of the faucet, which facilitates the storage of the ultrasonic generator, and could increase the convenience of taking and placing and make the operation faster.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1 is a perspective view of the faucet according to a first embodiment of the present invention;

FIG. 2 is a partially front view of the faucet according to the first embodiment of the present invention;

FIG. 3 is similar to FIG. 1, showing the ultrasonic generator located outside the receiving groove;

FIG. 4 is a partially exploded view of the faucet according to the first embodiment of the present invention;

FIG. 5 is a cross-sectional view along the 5-5 line in FIG. 2;

FIG. 6 is a partially enlarged view of a marked region A in FIG. 5;

FIG. 7 is similar to FIG. 5, showing the pressing unit is pressed to drive the locking unit located in a second position to release the ultrasonic generator; and

FIG. 8 is a partially enlarged view of a marked region B in FIG. 7.

### DETAILED DESCRIPTION OF THE INVENTION

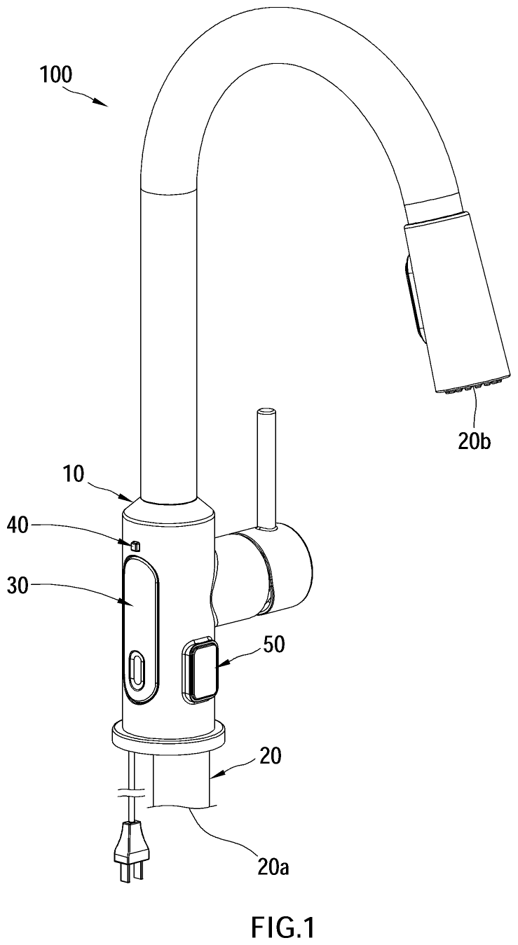

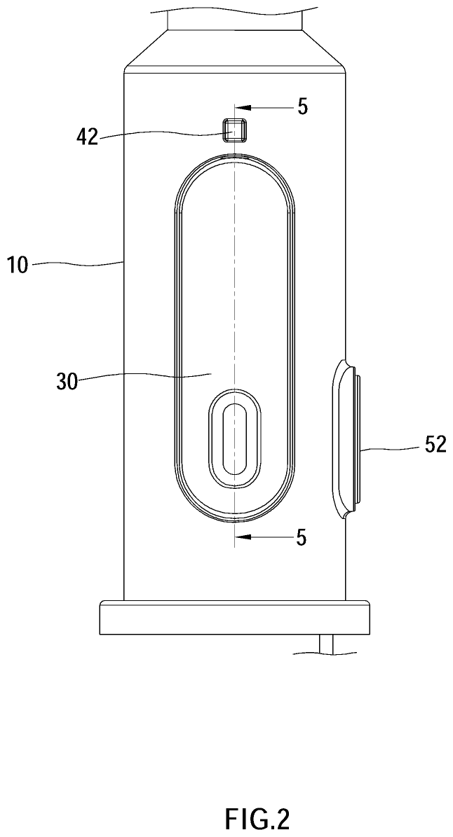

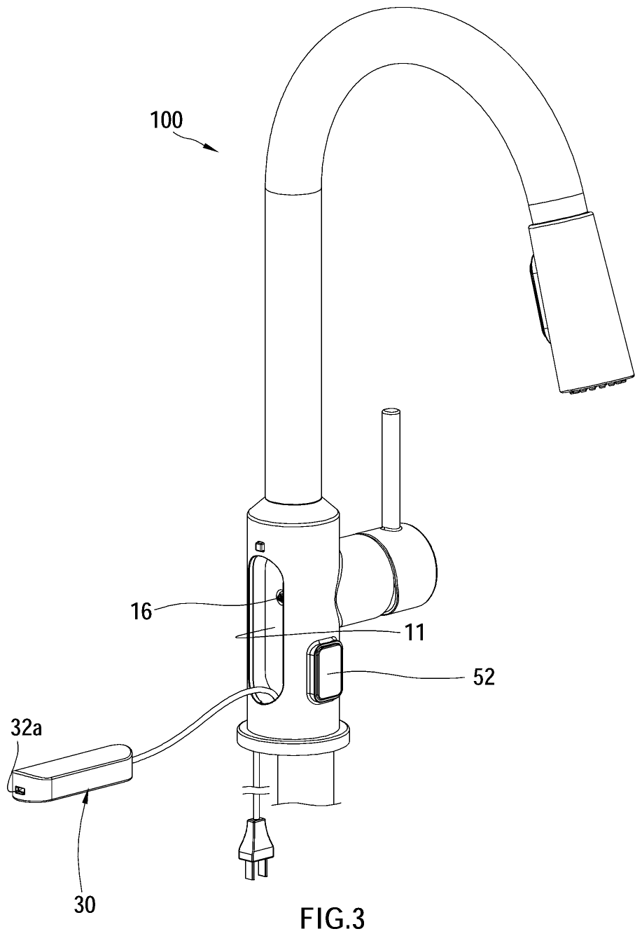

A faucet 100 according to a first embodiment of the present invention is illustrated in FIG. 1 to FIG. 3 and includes a base 10, an outlet pipe 20, and an ultrasonic generator 30.

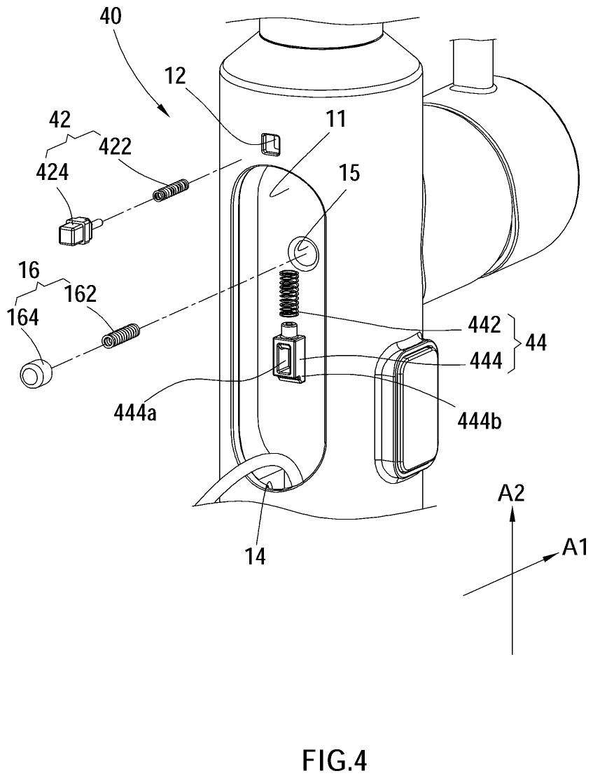

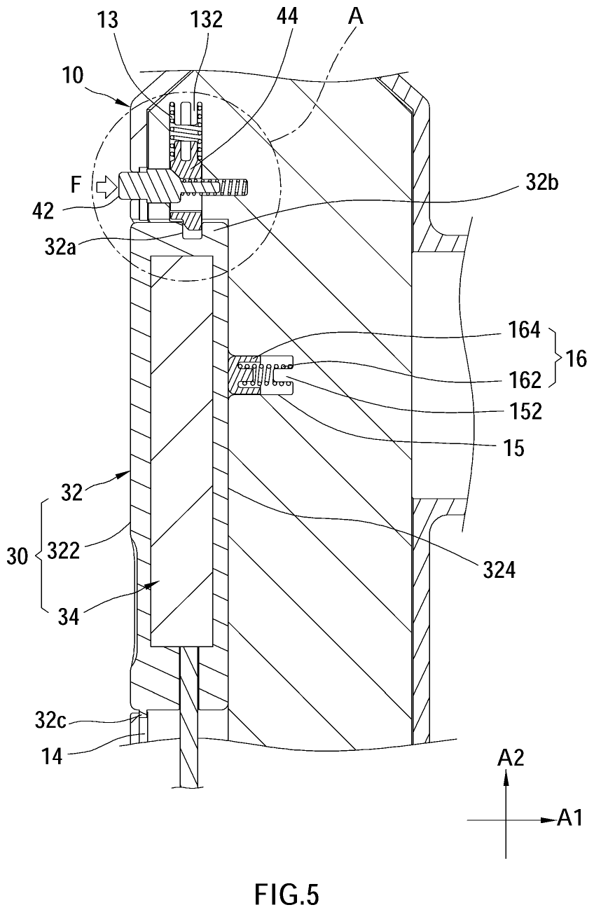

As shown in FIG. 4 and FIG. 5, the base 10 has a receiving groove 11, a first receiving groove 12, a second receiving groove 13, a notch 14, and a positioning groove 15, wherein the receiving groove 11 is recessed into an outer surface of the base 10 along a first axial direction A1 to form an opening on the outer surface of the base 10, and the first receiving groove 12 is recessed into the outer surface of the base 10 along the first axial direction A1 to form an opening on the outer surface of the base 10. The second receiving groove 13 is recessed into a groove wall of the receiving groove 11 along a second axial direction A2 and communicates with the first receiving groove 12, that is the first axial direction and the second axial direction perpendicularly intersect. A bottom surface of the second receiving groove 13 has a projection 132. The notch 14 is disposed on a peripheral edge of the opening of the receiving groove 11 and is located on a side of the receiving groove 11 opposite to the second receiving groove 13.

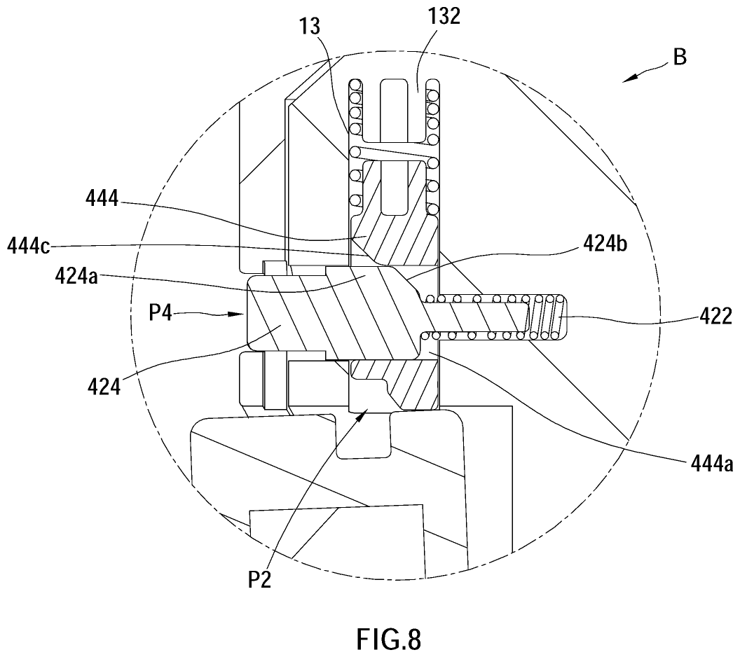

As shown in FIG. 4 to FIG. 6, a fixing mechanism 40 is disposed in the first receiving groove 12 and the second receiving groove 13, and includes a pressing unit 42 and a locking unit 44, wherein the pressing unit 42 has a first spring 422 and a pressing member 424. An end of the first spring 422 is connected to a bottom surface of the first receiving groove 12, and another end of the first spring 422 is connected to the pressing member 424. The pressing member 424 has an abutting section 424a adapted to be coupled with the locking unit 44, wherein the abutting section 424a has a first abutting surface 424b. The pressing unit 42 could be moved from a third position P3 to a fourth position P4 when the pressing unit 42 is pressed by an external force F (as shown in FIG. 8), wherein at this time, the pressing member 424 moves along the first axial direction A1 toward the bottom surface of the first receiving groove 12, and the first spring is compressed.

The locking unit 44 of the fixing mechanism 40 includes a second spring 442 and a locking member 444, wherein an end of the second spring 442 fits around the projection 132 at the bottom surface of the second receiving groove 13, and another end of the second spring 442 is connected to the locking member 444. The locking member 444 has a through hole 444a and a protrusion 444b, wherein the through hole 444a is formed along the first axial direction A1, and the protrusion 444b protrudes in a direction away from the second spring 442 along the second axial direction A2. The pressing unit 42 passes through the through hole 444a, and the abutting section 424a of the pressing member 424 abuts against a hole wall of the through hole 444a. The hole wall of the through hole 444a has a second abutting surface 444c corresponding to the first abutting surface 424b of the abutting section 424a. When the pressing unit 42 moves from the third position P3 to the fourth position P4, the locking unit 44 is driven from a first position P1 to a second position P2. When the locking unit 44 is located at the first position P1, the first abutting surface 424b of the pressing member 424 abuts against the second abutting surface 444c of the locking member 444, and the locking member 444 protrudes out of the second receiving groove 13. When the locking unit 44 is located at the second position P2, the locking member 444 is located in the second receiving groove 13, and the second spring 442 is compressed.

The positioning groove 15 of the base 10 is recessed into a bottom surface of the receiving groove 11 along the first axial direction A1, wherein a projection 152 protrudes from a bottom surface of the positioning groove 15. The base 10 has a disengaging unit 16 configured corresponding to the positioning groove 15, wherein the disengaging unit 16 includes a spring 162 and a disengaging member 164. An end of the spring 162 of the disengaging unit 16 fits around the projection 152 of the positioning groove 15, and another end of the spring 162 of the disengaging unit 16 is connected to the disengaging member 164. When the disengaging member 164 is pushed toward the bottom surface of the positioning groove 15 by an external force, the disengaging member 164 drives the spring 162 to compress, thereby the disengaging member 164 is located in the positioning groove 15. When the external force exerted on the disengaging member 164 is released, the spring 162 restores to its natural length and pushes the disengaging member 164 outward to make the disengaging member 164 protrudes from the positioning groove 15. The disengaging unit 16 is not limited by the aforementioned design. In other embodiments, the disengaging unit 16 could be, but not limited to, an elastic plate.

The outlet pipe 20 penetrates the base 10 and has an inlet end 20a and an outlet end 20b, wherein the inlet end 20a is adapted to be connected to an external water source (not shown), so that water flows through the inlet end 20a and flows out from the outlet end 20b.

As shown in FIG. 5, the ultrasonic generator 30 is detachably disposed in the receiving groove 11 of the base 10 and includes a case 32 and an ultrasonic vibration element 34 disposed inside the case 32, wherein the case 32 has a first surface 322 and a second surface 324 which faces opposite directions. The first surface 322 faces the opening of the receiving groove 11, and the second surface 324 faces the bottom surface of receiving groove 11. The case 32 has a recess 32a corresponding to the second receiving groove 13 on a side of the case 32 facing the second receiving groove 13. The recess 32a is recessed along the second axial direction A2, and a projection 32b is formed between the recess 32a and the second surface 324. The case 32 has a block 32c on a side opposite to the projection 32b formed between the recess 32a and the second surface 324. The block 32c is configured corresponding to the notch 14 of the base 10. An end of the disengaging member 164 is pushed by the second surface 324 to make the disengaging unit 16 located in the positioning groove 15, and the spring 162 of the disengaging unit 16 is compressed.

A power switch 50 is disposed on the base 10 of the faucet 100 and is electrically connected between the ultrasonic generator 30 and an external power (not shown) by a wire. The power switch 50 has an operating portion 52 disposed on the outer surface of the base 10. The user could turn on or off the power from the external power to the ultrasonic generator 30 by operating the operating portion 52. In the current embodiment, the operating portion 52 is, but not limited to, a button. In other embodiments, the operating portion could be a touch panel.

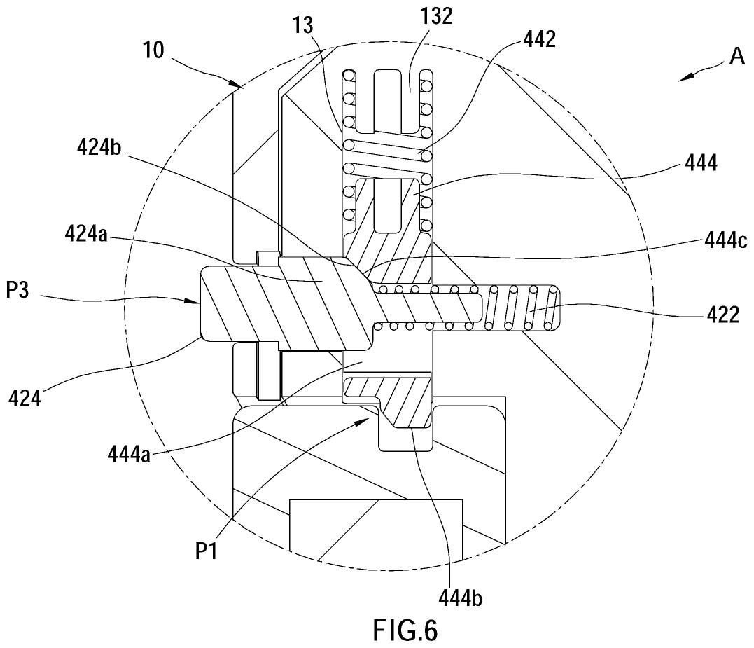

As shown in FIG. 5 and FIG. 6, the ultrasonic generator 30 is located in the receiving groove 11, and the pressing unit 42 is located at the third position P3, thereby to make the locking unit 44 be located at the first position P1. At this time, the protrusion 444b of the locking member 444 is located in the recess 32a of the ultrasonic generator 30 and abuts against the projection 32b of the ultrasonic generator 30. The block 32c abuts against a wall surface of the notch 14, thereby restricting the ultrasonic generator 30 in the receiving groove 11, and the ultrasonic generator 30 does not protrude from the outer surface of the base 10 due to being pushed by the disengaging unit 16. The disengaging unit 16 is pressed by the second surface 324 of the ultrasonic generator 30 to be located in the positioning groove 15, and the spring 162 of the disengaging unit 16 is in a compressed state.

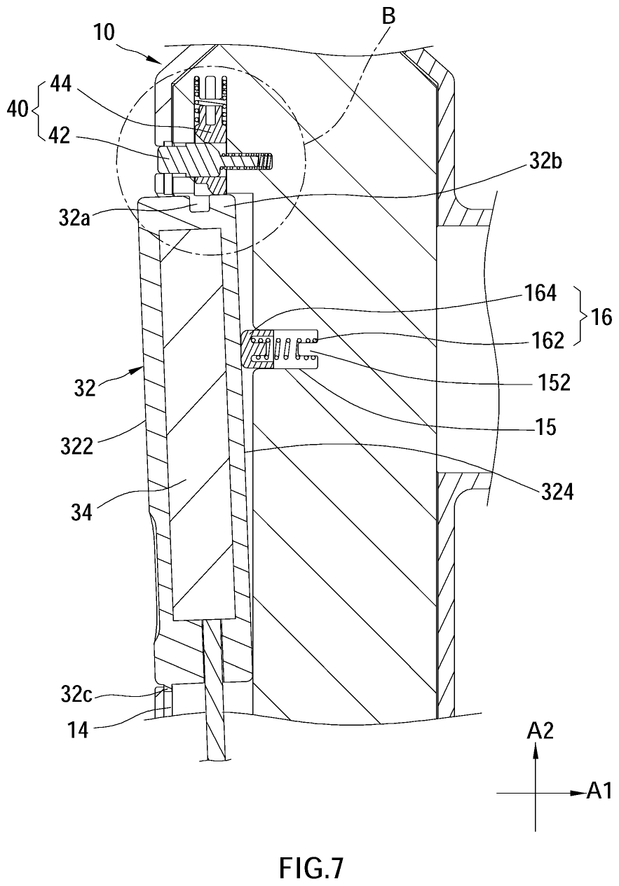

As shown in FIG. 7 and FIG. 8, during a process that the user presses the pressing member 424 to move the pressing member 424 from the third position P3 to the fourth position P4, the pressing member 424 exerts an external force F to the first spring 422 to make the first spring 422 compresses toward the bottom surface of the receiving groove 12. The first abutting surface 424b of the pressing member 424 obliquely pushes the second abutting surface 444c of the locking member 444 upward to gradually moves the locking member 444 upward. In addition, the locking member 444 exerts a pushing force on the second spring 442 to compress the second spring 442 toward the bottom surface of the second receiving groove 13, thereby moving the locking member 444 from the first position P1 to the second position P2.

When the pressing unit 42 is located at the fourth position P4 and the locking unit 44 is located at the second position P2, the protrusion 444b of the locking member 444 is located in the second receiving groove 13 and does not abut against the projection 32b of the ultrasonic generator 30. In this way, a top end of the ultrasonic generator 30 facing the fixing mechanism 40 in the second axial direction A2 is not restricted, and the spring 162 of the disengaging unit 16 restores to its natural length and pushes the ultrasonic generator 30 toward the opening of the receiving groove 11 to make the ultrasonic generator 30 protrudes from the outer surface of the base 10, and the disengaging unit 16 also protrudes from the bottom surface of the receiving groove 11 due to the spring 162 restores to its natural length. At the same time, the ultrasonic generator 30 could be taken out from the opening of the receiving groove 11 by slightly pulling the ultrasonic generator 30.

More specifically, when the user no longer applies the external force to the pressing member 424, the first spring 422 pushes the pressing member 424 from the fourth position P4 back to the third position P3. In addition, after the projection 32b of the ultrasonic generator 30 leaves the protrusion 444b of the locking member 444, the second spring 162 restores to its natural length and pushes the locking member 444 to move toward the recess 32a of the ultrasonic generator 30 in the second axial direction A2, thereby pushing the locking member 444 from the second position P2 back to the first position P1 (i.e., returns to the state that the protrusion 444b of the locking member 444 protrudes out of the second receiving groove 13).

After taking out the ultrasonic generator 30 with the aforementioned way, the ultrasonic generator 30 could be placed in a sink. The ultrasonic waves generated when the ultrasonic vibrating element 34 in the ultrasonic generator 30 is activated and makes the dirt on the dishes remove easier and improve the effect of cleaning.

In addition, when there is no need to use the ultrasonic generator 30, the ultrasonic generator 30 could be placed back by putting a bottom of the ultrasonic generator 30 having the block 32c into the receiving groove 11 first, and the block 32c of the ultrasonic generator 30 could be abutted against the notch 14 to form a supporting point, and the ultrasonic generator 30 is pushed into the receiving groove 11 by an external force. During a process of pushing the ultrasonic generator 30 into the receiving groove 11, the pressing member 424 could be pressed to drive the locking member 444 to move to the second position P2, so that the locking member 444 would not hinder the ultrasonic generator 30 from entering the receiving groove 11. Alternatively, the protrusion 444b of the locking member 444 could be move to the second position P2 by being pushed by the ultrasonic generator 30, and the protrusion 444b of the locking member 444 would move to the first position P1 when the recess 32a of the ultrasonic generator 30 corresponds to the protrusion 444b of the locking member 444, thereby restricting the ultrasonic generator 30 in the receiving groove 11.

In summary, the structural design of the ultrasonic generator engaged with the faucet allows the ultrasonic generator to be conveniently received in the receiving groove of the faucet, and the process of taking and placing the ultrasonic generator could be also convenient for the user.

It must be pointed out that the embodiments described above are only some preferred embodiments of the present invention. All equivalent structures which employ the concepts disclosed in this specification and the appended claims should fall within the scope of the present invention.

What is claimed is:

1. A faucet, comprising:
a base having a receiving groove, wherein the receiving groove has an opening formed on an outer surface of the base;
an outlet pipe engaged with the base, wherein the outlet pipe has an inlet end and an outlet end; and
an ultrasonic generator detachably disposed in the receiving groove via the opening.

2. The faucet as claimed in claim 1, wherein a disengaging unit is disposed on a bottom surface of the receiving groove; the disengaging unit exerts a force on the ultrasonic generator to push the ultrasonic generator in a direction toward the opening.

3. The faucet as claimed in claim 2, further comprising a fixing mechanism disposed on the base, wherein the fixing mechanism is adapted to restrict the ultrasonic generator in the receiving groove.

4. The faucet as claimed in claim 3, wherein the fixing mechanism comprises a pressing unit and a locking unit; the pressing unit drives the locking unit to move between a first position to a second position; when the locking unit is located at the first position, the locking unit abuts against the ultrasonic generator to restrict the ultrasonic generator in the receiving groove; when the locking unit is located at the second position, the locking unit is apart from the ultrasonic generator.

5. The faucet as claimed in claim 4, wherein the pressing unit protrudes from the outer surface of the base; the pressing unit is movable along a first axial direction; the locking unit is movable along a second axial direction; the first axial direction intersects the second axial direction.

6. The faucet as claimed in claim 5, wherein the base has a first receiving groove and a second receiving groove; the first receiving groove is recessed into the outer surface of the base; the second receiving groove is recessed into a groove wall of the receiving groove and communicates with the first receiving groove; the pressing unit is disposed on the first receiving groove; the locking unit has a through hole and a protrusion; the locking unit is disposed on the second receiving groove, and the pressing unit passes through the through hole; the ultrasonic generator has a projection on a side facing the second receiving groove; when the locking unit is located at the first position, the protrusion of the locking unit abuts against the projection of the ultrasonic generator; the pressing unit pushes a hole wall of the through hole when the pressing unit moves along the first axial direction, thereby to drive the locking unit to move to the second position; when the locking unit is located at the second position, the protrusion of the locking unit does not abuts against the projection of the ultrasonic generator.

7. The faucet as claimed in claim 6, wherein the pressing unit comprises a first spring and a pressing member; an end of the first spring is connected to a bottom surface of the first receiving groove, and another end is connected to the pressing member; the locking unit comprises a second spring and a locking member; an end of the second spring is connected to a bottom surface of the second receiving groove, and another end is connected to the locking member; the locking member has the through hole and the protrusion; the pressing member passes through the through hole of the locking member; when the pressing unit is pressed by an external force to move from a third position to a fourth position, the first spring is compressed, and the pressing member abuts against the hole wall of the through hole of the locking member, thereby driving the locking member to move in a direction toward the bottom surface of the second receiving groove, and the second spring is compressed to make the protrusion of the locking member apart from the projection of the ultrasonic generator; when the external force is released, the first spring pushes the pressing member back to the third position, and the second spring pushes the locking member back to the first position.

8. The faucet as claimed in claim 7, wherein the pressing member has an abutting section; the abutting section has a first abutting surface; the hole wall of the through hole of the locking member has a second abutting surface corresponding to the first abutting surface; when the pressing member moves from the third position to the fourth position, the first abutting surface pushes the second abutting surface to move the locking member to the second position.

9. The faucet as claimed in claim 4, wherein a positioning groove is formed on the bottom surface of the receiving groove; the disengaging unit is disposed in the positioning groove; the disengaging unit comprises a spring and a disengaging member; an end of the spring is connected to a bottom surface of the positioning groove, and another end is connected to the disengaging member; when the locking unit is located at the first position and the ultrasonic generator is located in the receiving groove, the disengaging member is located in the positioning groove and abuts against the ultrasonic generator, and the spring is compressed; when the locking unit is located at the second position, the spring pushes the disengaging member to protrude from the bottom surface of the receiving groove and pushes the ultrasonic generator in the direction toward the opening.

10. The faucet as claimed in claim 6, wherein the groove wall of the receiving groove has a notch; the notch is located on a side of the receiving groove opposite to the second receiving groove and is adjacent to the opening; the ultrasonic generator has a block on a side opposite to the projection of the ultrasonic generator; when the ultrasonic generator is placed in the receiving groove and the locking unit is located at the first position, the block of the ultrasonic generator abuts against a wall surface of the notch.
